(19) United States
(12) Patent Application Publication
(10) Pub. No.: US 2011/0141716 A1
(43) Pub. Date: Jun. 16, 2011

(54) Illumination Device for Backlighting a Display, and a Display Comprising such an Illumination Device

(75) Inventors: Burkard Wiesmann, Regensburg (DE); Markus Zeiler, Undorf-Nittendorf (DE); Herbert Brunner, Sinzing (DE); Hubert Ott, Bad Abbach (DE); Ludwig Ploetz, Arnschwang (DE); Joerg Strauss, Augsburg (DE)

(73) Assignee: OSRAM Opto Semiconductors GmbH, Regensburg (DE)

(21) Appl. No.: 12/865,850

(22) PCT Filed: Jan. 16, 2009
(86) PCT No.: PCT/DE2009/000044

§ 371 Date: Jan. 26, 2011

(30) Foreign Application Priority Data
Jan. 31, 2008 (DE) 10 2008 006 975.2
Jun. 19, 2008 (DE) 10 2008 029 191.9

(51) Int. Cl. G09F 13/04

(52) U.S. Cl. 362/97.1

(57) ABSTRACT

An illumination device (1) for backlighting a display is disclosed. The illumination device comprises: at least one semiconductor body (3), suitable for generating electromagnetic radiation of a first wavelength range, a first wavelength conversion substance (30), which is disposed downstream of the radiation-emitting front side (6) of the semiconductor body (3) in the emission direction (8) thereof and is suitable for converting radiation of the first wavelength range into radiation of a second wavelength range, which is different from the first wavelength range, and a second wavelength conversion substance (31), which is disposed downstream of the radiation-emitting front side (6) of the semiconductor body (3) in the emission direction (8) thereof and is suitable for converting radiation of the first wavelength range into radiation of a third wavelength range, which is different from the first and second wavelength ranges. A display comprising such an illumination device (1) is furthermore described.

The invention relates to an illumination device for backlighting a display, and to a display comprising such an illumination device.

An illumination device for a display is specified for example in the document DE 10 2004 046 696.3.

It is an object of the invention to specify an improved illumination device for backlighting a display.

These objects are achieved by means of an illumination device comprising the features of patent claim 1 and by means of a display comprising the features of patent claim 14.

Such an illumination device for backlighting a display comprises, in particular:
at least one semiconductor body, suitable for generating electromagnetic radiation of a first wavelength range,
a first wavelength conversion substance, which is disposed downstream of the radiation-emitting front side of the semiconductor body in the emission direction thereof and is suitable for converting radiation of the first wavelength range into radiation of a second wavelength range, which is different from the first wavelength range, and
a second wavelength conversion substance, which is disposed downstream of the radiation-emitting front side of the semiconductor body in the emission direction thereof and is suitable for converting radiation of the first wavelength range into radiation of a third wavelength range, which is different from the first and second wavelength ranges.

The illumination device comprises at least one semiconductor body as light source. Semiconductor bodies afford the advantage for example over conventionally employed cold cathode fluorescent lamps (CCFL) that they are less sensitive to vibrations and are substantially freely dimmable and enable fast switching times. Furthermore, in comparison with cold cathode fluorescent lamps, semiconductor bodies comprise substantially no or only a very small proportion of harmful heavy metals, such as mercury or lead.

Particularly preferably, the semiconductor body and the two wavelength conversion substances are arranged in such a way that radiation of the first wavelength range which is generated by the semiconductor body impinges at least partly on the first and the second wavelength conversion substance, such that radiation of the first wavelength range is converted into radiation of the second and third wavelength ranges by the two wavelength conversion substances.

The radiation of the first wavelength range which is emitted by the semiconductor body is converted by the first wavelength conversion substance preferably partly into radiation of a second wavelength range, which is different from the first wavelength range, and by the second wavelength conversion substance likewise preferably partly into radiation of a third wavelength range, which is different from the first and second wavelength ranges, while a further part of the radiation of the first wavelength range remains unconverted. In this case, the illumination device emits mixed radiation comprising unconverted radiation of the first wavelength range and converted radiation of the second and the third wavelength range.

The first and/or the second wavelength conversion substance can be contained in a wavelength converting layer, for example. Particularly preferably, the wavelength converting layer with the first and/or the second wavelength conversion substance is applied in direct contact onto the radiation-emitting front side of the semiconductor body. This means that the wavelength converting layer has a common interface with the radiation-emitting front side of the semiconductor body. If the wavelength converting layer is arranged on the radiation-emitting front side of the semiconductor body, then the semiconductor body, in relation to the dimensions of the illumination device, generally substantially constitutes a point radiation source which emits radiation with a specific color locus, preferably in the white region of the CIE standard chromaticity diagram. Radiation from such a point radiation source is suitable, in particular, for being coupled into an optical element.

Furthermore, it is also possible for the wavelength converting layer, which comprises at least one of the wavelength conversion substances, but preferably both wavelength conversion substances, to be arranged at a different location of the illumination device in such a way that radiation from the semiconductor body passes through the wavelength converting layer. The wavelength converting layer can be arranged for example on a rear side of a cover plate of the illumination device, said rear side facing the semiconductor body. The cover plate can be a diffuser plate, for example.

The semiconductor body can be mounted into a component housing. The component housing has a recess, for example, in which the semiconductor body is fixed. A suitable component housing is described for example in the document WO 02/084749 A2, the disclosure content of which in this regard is hereby incorporated by reference. If the semiconductor body is mounted into a component housing, then semiconductor body and component housing are part of an optoelectronic component which is in turn comprised by the illumination device.

In accordance with a further embodiment of the illumination device, the first and/or second wavelength conversion substance is introduced into a matrix material. The matrix material can for example comprise silicone and/or epoxide or consist of at least one of these materials.

The matrix material with at least one wavelength conversion substance can be embodied as a wavelength converting layer, or as a potting.

In accordance with one embodiment of the illumination device, the wavelength converting layer has a thickness of between 20 μm and 200 μm, inclusive of the limits.

In order to produce the wavelength converting layer, the matrix material with at least one wavelength conversion substance can be formed for example as a layer within the optoelectronic component or the illumination device and subsequently be cured. Such a wavelength converting layer preferably has a thickness of between 20 μm and 40 μm, inclusive of the limits.

As an alternative, it is also possible for the wavelength converting layer to be produced separately as a lamina. Such a lamina can either likewise comprise a matrix material into which particles of at least one wavelength conversion substance are introduced, or else for instance be embodied as ceramic. A wavelength converting layer which is produced separately as a lamina preferably has a thickness of between 20 μm and 200 μm, inclusive of the limits.

In accordance with a further embodiment of the illumination device, the first and/or the second wavelength conversion substance is embedded into a potting. The potting can be introduced for example into the recess of the component housing. In this case, the potting generally encapsulates the semiconductor body.

Furthermore, it is also possible for one of the two wavelength conversion substances to be comprised by a wavelength converting layer and for the other wavelength conversion substance to be comprised by a potting.

Furthermore, it is also possible for the two wavelength conversion substances to be introduced into two different wavelength converting layers. In this case, by way of example, the first wavelength conversion substance is introduced into a first wavelength converting layer, while the second wavelength conversion substance is introduced into a second wavelength converting layer. In this case, by way of example, one of the two wavelength converting layers can be applied in direct contact onto the radiation-emitting front side of the semiconductor body, while the second wavelength converting layer is applied in direct contact onto the first wavelength converting layer, that is to say that the second wavelength converting layer forms a common interface with the first wavelength converting layer.

In accordance with a further embodiment of the illumination device, the semiconductor body emits radiation of a first wavelength range comprising radiation from the blue spectral range.

A semiconductor body which emits radiation of the blue spectral range is preferably based on a nitride compound semiconductor material.

Nitride compound semiconductor materials are compound semiconductor materials which contain nitrogen, such as, for example, materials from the system InₓAl_{y}Ga_{1-x-y}N where 0≦x≦1, 0≦y≦1 and x+y≦1. The group of the radiation-emitting semiconductor bodies based on nitride compound semiconductor material includes in the present case in particular those semiconductor bodies in which an epitaxially grown semiconductor layer sequence of the semiconductor body contains at least one individual layer comprising a material composed of the nitride compound semiconductor material.

In accordance with a further embodiment of the illumination device, the second wavelength range comprises radiation of the green spectral range. The first wavelength conversion substance therefore preferably converts radiation of the first wavelength range into radiation of the green spectral range. Particularly preferably, in this embodiment, the first wavelength range comprises radiation of the blue spectral range.

In accordance with a further embodiment of the illumination device, the first wavelength conversion substance comprises a europium-doped chlorosilicate or consists of this material. A europium-doped chlorosilicate is suitable, in particular, for converting radiation of the blue spectral range into radiation of the green spectral range.

In accordance with a further embodiment of the illumination device, the third wavelength range preferably comprises radiation from the red spectral range. The second wavelength conversion substance therefore particularly preferably converts radiation of the first wavelength range into radiation of the red spectral range. Particularly preferably, in this embodiment, the first wavelength range once again comprises radiation of the blue spectral range.

In accordance with a further embodiment of the illumination device, the second wavelength conversion substance comprises a europium-doped silicon nitride or consists of this material. A europium-doped silicon nitride is suitable, in particular, for converting radiation of the blue spectral range into radiation of the red spectral range.

In accordance with a further embodiment of the illumination device, the latter comprises a europium-doped chlorosilicate as first wavelength conversion substance and a europium-doped silicon nitride as second wavelength conversion substance, wherein the two wavelength conversion substances preferably have a ratio with respect to one another of between 0.8 and 1.2 (relative to mass fractions), inclusive of the limits. Particularly preferably, the two wavelength conversion substances have a ratio with respect to one another of between 0.9 and 1.1 (likewise relative to mass fractions), likewise inclusive of the limits.

The first and/or the second wavelength conversion substance can furthermore be chosen from the group formed by the following materials: garnets doped with rare earth metals, alkaline earth metal sulfides doped with rare earth metals, thiogallates doped with rare earth metals, aluminates doped with rare earth metals, orthosilicates doped with rare earth metals, chlorosilicates doped with rare earth metals, alkaline earth metal silicon nitrides doped with rare earth metals, oxynitrides doped with rare earth metals, and aluminum oxynitrides doped with rare earth metals.

In accordance with a further embodiment, the illumination device emits mixed radiation having a color locus in the white region of the CIE standard chromaticity diagram. In this case, the white mixed radiation particularly preferably comprises radiation of the first wavelength range comprising radiation of the blue spectral range, radiation of the second wavelength range comprising green radiation, and radiation of the third wavelength range comprising red radiation.

In accordance with a further embodiment, an optical element is arranged above the semiconductor body, the first wavelength conversion substance and the second wavelength conversion substance. The semiconductor body can for example be arranged in the recess of a component housing and be provided on its radiation-emitting front side with the wavelength converting layer comprising the first and the second wavelength conversion substance, while the optical element is fixed on the component housing above the recess. In this case, the optical element is part of the optoelectronic component. The optical element generally serves for beam shaping. Particularly preferably, the optical element serves in the present case for beam expanding, in order to obtain an emission characteristic of the illumination device that is as homogeneous as possible, such as is generally desirable for backlighting a display. In particular, a homogeneous emission characteristic of the illumination device generally advantageously contributes to a small installation depth of the illumination device.

By way of example, a lens can be used as optical element.

Particularly preferably, use is made of an optical element having a radiation exit area which has a concavely curved partial region and a convexly curved partial region, which at least partly surrounds the concave partial region at a distance from the optical axis, wherein an optical axis of the optical element runs through the concavely curved partial region. An illumination device comprising such an optical element is described for example in the document WO 2006/089523, the disclosure content of which in this regard is hereby incorporated by reference.

Such an optical element is in particular advantageously suitable for expanding the emission characteristic of the optoelectronic component, that is to say for distributing the radiation emitted by the semiconductor body or the wavelength converting layer on the front side of the semiconductor body over a large solid angle.

In accordance with one embodiment, the illumination device comprises a plurality of semiconductor bodies and/or optoelectronic components comprising semiconductor bodies. In this case, all or some semiconductor bodies and/or optoelectronic components can have the features described in the present case for a semiconductor body and/or an optoelectronic component.

If the illumination device comprises a plurality of semiconductor bodies and/or optoelectronic components, then they preferably emit radiation having the same wavelength or having a spectrum of equal type.

If the illumination device comprises a plurality of semiconductor bodies and/or optoelectronic components, then they are preferably grouped in accordance with their color loci. That is to say that the color loci of the radiation emitted by the semiconductor bodies and/or optoelectronic components are preferably situated within a MacAdam ellipse with three SDCM (Standard Deviation of Color Matching). A MacAdam ellipse is a range within the CIE standard chromaticity diagram of those distances of hues with respect to a reference hue which are perceived identically by a human observer. The dimensions of the MacAdam ellipse are specified in SDCM. In other words, the color loci of the radiation emitted by the semiconductor bodies and/or optoelectronic components deviate by not more than three SDCM from a predetermined value.

MacAdam ellipses and SDCM are described in the document MacAdam, D. L., Specification of small chromaticity differences, Journal of the Optical Society of America, vol. 33, no. 1, January 1943, pp 18-26, the disclosure content of which in this regard is incorporated by reference.

Particularly if the illumination device comprises a plurality of semiconductor bodies and/or optoelectronic components which emit mixed radiation having a color locus in the white region of the CIE standard chromaticity diagram, the color loci deviate by not more than three SDCM from one another. Since the human eye is particularly sensitive to color locus fluctuations in the white region of the CIE standard chromaticity diagram, a particularly homogeneous color impression of the radiation of the illumination device can thus be achieved.

If mixed radiation is generated by means of a wavelength converting layer on the radiation-emitting front side of the semiconductor body, then it equivalently holds true that the semiconductor bodies with the wavelength converting layer are preferably grouped in accordance with their color loci, the color locus referring to the mixed radiation emitted by the wavelength converting layer.

Particularly preferably, the illumination device described here is comprised by a display for backlighting. The display can be a liquid crystal display (LCD display), for example.

The display preferably has a color filter with at least three different regions which are respectively embodied in a manner transmissive to radiation of three different wavelength ranges. Particularly preferably, the emission spectrum of the radiation emitted by the illumination device is adapted to the color filter. That is to say that the emission spectrum of the radiation emitted by the illumination device has at least three different wavelength ranges with a respective peak which are transmitted at least to the extent of 30 percent by one of the three different regions of the color filter. Consequently, the different regions of the color filter respectively have a transmission spectrum which substantially respectively corresponds to a peak of the emission spectrum of the illumination device. If the emission spectrum of the radiation of the illumination device is adapted to a color filter, then the color filter transmits a particularly large proportion of the radiation emitted by the illumination device. Particularly preferably, a color filter to which the emission spectrum of the radiation of the illumination device is adapted transmits at least 40 percent of the radiation emitted by the illumination device.

Particularly preferably, the emission spectrum of an illumination device which emits white mixed radiation comprising blue radiation of the first wavelength range, green radiation of the second wavelength range and red radiation of the third wavelength range is adapted to a color filter having red regions, green regions and blue regions. In this case, the emission spectrum of the mixed radiation of the illumination device is composed of the emission spectrum of the first wavelength range, the emission spectrum of the second wavelength range and the emission spectrum of the third wavelength range and has a peak in the red spectral range, a peak in the green spectral range and a peak in the blue spectral range.

If the emission spectrum of the illumination device is adapted to a color filter with red regions, green regions and blue regions, then, in accordance with a first aspect, an emission spectrum of the red radiation of the third wavelength range is adapted to a transmission spectrum of the red region of the color filter. That is to say that at least 55 percent of the red radiation of the third wavelength range is transmitted by the red region of the color filter. Furthermore, in accordance with a second aspect, an emission spectrum of the green radiation of the second wavelength range is adapted to a transmission spectrum of the green region of the color filter in such a way that at least 65 percent of the green radiation of the second wavelength range is transmitted by the green region of the color filter. Likewise, in accordance with a third aspect, an emission spectrum of the blue radiation of the first wavelength range is adapted to a transmission spectrum of the blue region of the color filter in such a way that at least 55 percent of the blue radiation of the first wavelength range is transmitted by the blue region of the color filter.

An illumination device which emits white mixed radiation whose emission spectrum is adapted to a conventional color filter with a red, a green and a blue region comprises, for example, a semiconductor body which emits radiation from the blue spectral range, wherein a wavelength converting layer with a first and a second wavelength conversion substance is applied in direct contact onto the radiation-emitting front side of said semiconductor body.

In this case, the first wavelength conversion substance is particularly preferably a europium-doped chlorosilicate which converts a part of the blue radiation of the first wavelength range into green radiation, while a further part of the blue radiation of the first wavelength range passes through the wavelength converting layer without being converted.

In this embodiment, the second wavelength conversion substance used is particularly preferably a europium-doped silicon nitride which converts a further part of the blue radiation of the first wavelength range into red radiation, while a further part of the radiation of the first wavelength range passes through the wavelength converting layer without being converted. Particularly preferably, the europium-doped chlorosilicate and the europium-doped silicon nitride have a mixing ratio of between 0.8 and 1.2 (relative to mass fractions), inclusive of the limits.

Further features, advantageous configurations and expediencies of the invention will become apparent from the exemplary embodiments described below in conjunction with the figures.

In the figures:

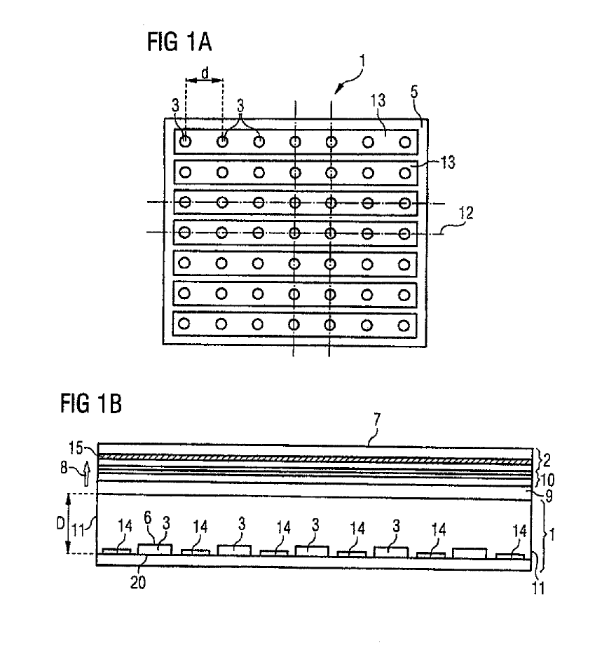

FIG. 1A shows a schematic plan view of an illumination device in accordance with one exemplary embodiment,

FIG. 1B shows a schematic sectional illustration of an LCD display comprising an illumination device in accordance with the exemplary embodiment of FIG. 1A,

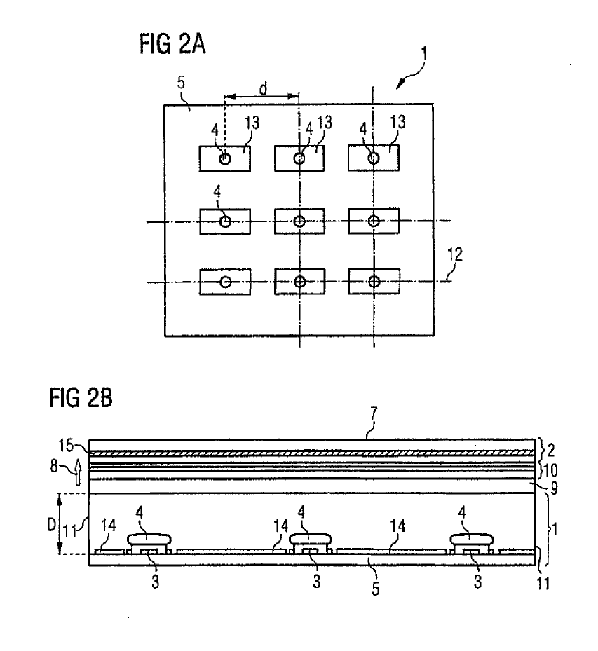

FIG. 2A shows a schematic plan view of an illumination device in accordance with a further exemplary embodiment,

FIG. 2B shows a schematic sectional illustration of an LCD display comprising an illumination device in accordance with the exemplary embodiment of FIG. 2A,

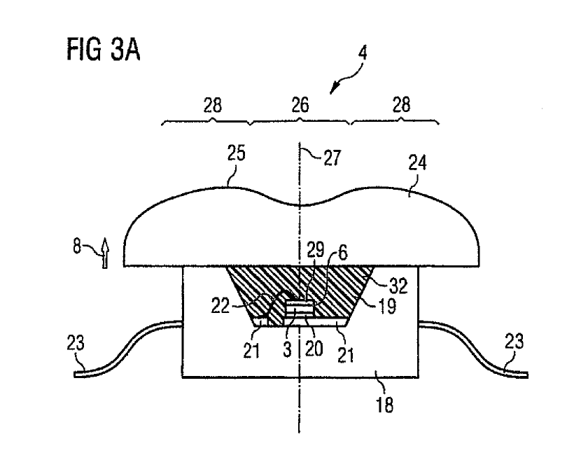

FIG. 3A shows a schematic sectional illustration of an optoelectronic component in accordance with one exemplary embodiment,

FIG. 3B shows a schematic perspective illustration of an optoelectronic component in accordance with the exemplary embodiment of FIG. 3A,

FIG. 3C shows a schematic sectional illustration of the optical element of the optoelectronic component in accordance with FIGS. 3A and 3B and a schematic ray path within this optical element,

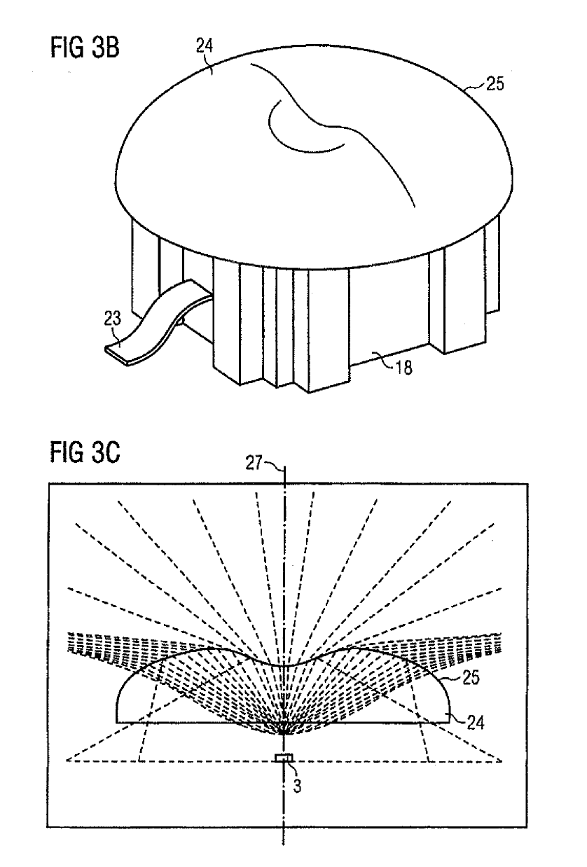

FIGS. 4A and 4B each shows a schematic sectional illustrations of a semiconductor body in accordance with one exemplary embodiment in each case,

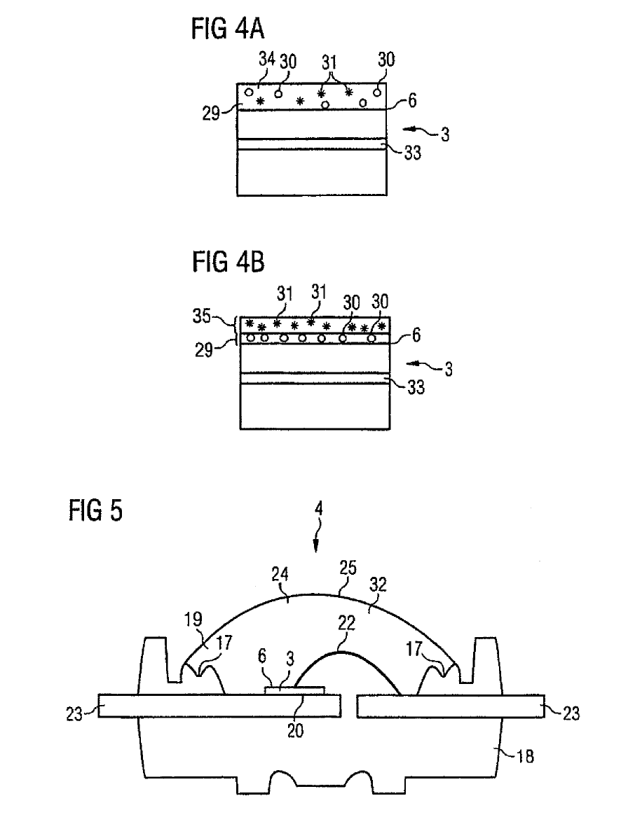

FIG. 5 shows a schematic sectional illustration of an optoelectronic component in accordance with a further exemplary embodiment,

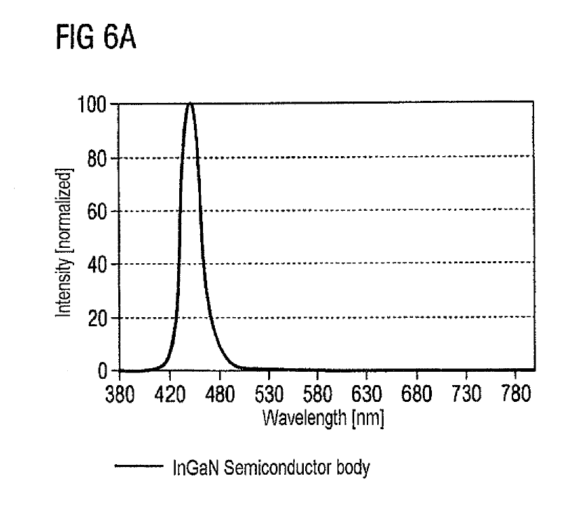

FIG. 6A shows a graphical illustration of the emission spectrum of a semiconductor body in accordance with one exemplary embodiment,

FIG. 6B shows a graphical illustration of the emission spectrum of two wavelength conversion substances and of a wavelength converting layer on a semiconductor body in accordance with one exemplary embodiment,

FIG. 6C shows a graphical illustration of an emission spectrum of a wavelength conversion substance and of a wavelength converting layer on a semiconductor body,

FIG. 6D shows a graphical illustration of the transmission spectra of a color filter for an LCD display in accordance with one exemplary embodiment, and

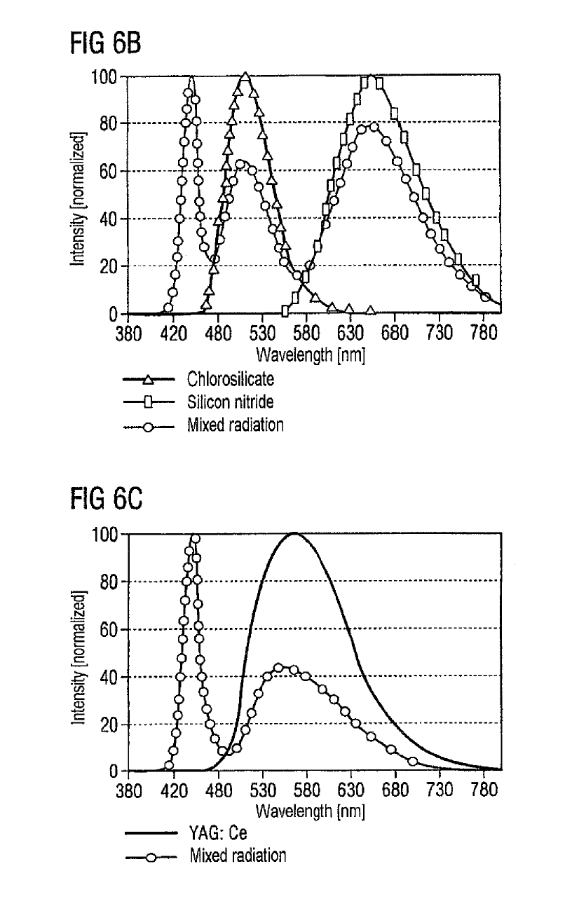

FIG. 7 shows a schematic illustration of the color triangle for an illumination device comprising a semiconductor body and wavelength conversion substances in accordance with the exemplary embodiment of FIG. 6B and of the color triangle for an illumination device comprising a semiconductor body and a wavelength conversion substance in accordance with FIG. 6C.

In the exemplary embodiments and figures, identical or identically acting constituent parts are respectively provided with the same reference symbols. The elements illustrated in the figures should not necessarily be regarded as true to scale. Rather, individual constituent parts, such as layer thicknesses, for example, may be illustrated in part with an exaggerated size in order to afford a better understanding.

The illumination device 1 in accordance with the exemplary embodiment of FIG. 1A has a carrier 5 and a plurality of semiconductor bodies 3. The semiconductor bodies 3 are not incorporated into a component housing, but rather are arranged with their rear side 20, which lies opposite their radiation-emitting front side 6, on strip-type carrier elements 13 at substantially equal distances d of approximately 30 mm. The strip-type carrier elements 13 with the semiconductor bodies 3 are applied, for their part, parallel to one another on the carrier 5, such that the semiconductor bodies 3 are arranged in a regular, square grid 12.

The semiconductor bodies 3 of the exemplary embodiment in accordance with FIG. 1A are embodied such that they are of equal type. In particular, the semiconductor bodies 3 emit radiation having a spectrum of equal type, the color locus of which preferably lies in the white region of the CIE standard chromaticity diagram. For this purpose, the semiconductor bodies 3 have for example one or two wavelength converting layers 29, 35 on their front side 6, as described in greater detail with reference to FIGS. 4A and 4B.

The carrier 5 can be a metal-core circuit board, for example, which also serves as a heat sink. Particularly preferably, the carrier 5 is covered with a reflective film 14 at least between the semiconductor bodies 3 or the carrier elements 13.

The LCD display in accordance with the exemplary embodiment of FIG. 1B comprises an illumination device 1 in accordance with the exemplary embodiment of FIG. 1A. In this case, the radiation-emitting front sides 6 of the semiconductor bodies 3 face a radiation-emitting front side 7 of the illumination device 1.

In a manner succeeding the semiconductor bodies 3 in the emission direction 8, a diffuser plate 9 is fitted at a distance D of approximately 30 mm, measured from the carrier 5. The diffuser plate 9 preferably has a thickness of between 1 mm and 3 mm, inclusive of the limits. A plurality of optical layers 10 and also an LCD layer 2 comprising liquid crystals are arranged in a manner succeeding the diffuser plate 9 in the emission direction 8. The optical layers 10 are structured plastic layers, for example, preferably having a thickness of between 150 μm and 300 μm. The optical layers 10 generally have the task of focusing radiation of the illumination device 1. Furthermore, a color filter 15 is integrated into the LCD layer 2. The side walls 11 of the LCD display are in the present case embodied in reflective fashion.

The illumination device 1 in accordance with FIGS. 1A and 1B furthermore comprises two wavelength conversion substances 30, 31, which are disposed downstream of the radiation-emitting front side 6 of the semiconductor bodies 3 in the emission direction 8 thereof. The wavelength conversion substances 30, 31 are not illustrated in FIGS. 1A and 1B, for reasons of clarity.

The first wavelength conversion substance 30 is suitable for converting radiation of a first wavelength range, which is generated by an active zone 33 of the semiconductor body 3, into radiation of a second wavelength range, which is different from the first wavelength range, while the second wavelength conversion substance 31 is suitable for converting radiation of the first wavelength range into radiation of a third wavelength range, which is different from the first and second wavelength ranges.

The wavelength conversion substances 30, 31 can be applied in one or two wavelength converting layers 29, 35, for example, onto the radiation-emitting front sides 6 of the semiconductor bodies 3, as explained in greater detail with reference to FIGS. 4A and 4B. Furthermore, it is also possible for only one wavelength conversion substance 30, 31 to be comprised by a wavelength converting layer 29, 35 and for the other wavelength conversion substance 30, 31 to be comprised by a potting 32.

It is likewise possible for the wavelength conversion substances 30, 31, as part of one or two wavelength converting layers 29, 35, to be disposed downstream of the radiation-emitting front sides 6 of the semiconductor bodies 3 at a different location, for example on the diffuser plate 9 or between the optical layers 10.

The illumination device 1 in accordance with FIG. 2A, in contrast to the illumination device 1 in accordance with the exemplary embodiment of FIG. 1A, has semiconductor bodies 3 which are part of an optoelectronic component 4, of a light-emitting diode in the present case. Optoelectronic components 4 such as can be used in the illumination device 1 in accordance with FIG. 2A will be explained in greater detail with reference to FIGS. 3A to 3C and 5.

In order to avoid repetitions, only the essential differences between the illumination device 1 in accordance with FIG. 2A and the illumination device 1 in accordance with FIG. 1A are described below. Unless mentioned otherwise, the remaining features of the illumination device 1 in accordance with FIG. 2A are embodied identically to those of the illumination device 1 in accordance with FIG. 1A.

In the case of the exemplary embodiment in accordance with FIG. 2A, the optoelectronic components 4 are respectively applied on an individual carrier element 13. These carrier elements 13 are applied onto a carrier 5 in such a way that the optoelectronic components 4 form a regular, square grid 12. The optoelectronic components 4 are at a distance d of approximately 80 mm from one another.

The LCD display in accordance with the exemplary embodiment of FIG. 2B has an illumination device 1 in accordance with the exemplary embodiment of FIG. 2A. The remaining elements and features of the LCD display in accordance with FIG. 2B are embodied substantially identically to those of the LCD display in accordance with FIG. 1B and will not be explained in further detail below, in order to avoid repetitions. In contrast to the LCD display in accordance with FIG. 1B, however, the diffuser plate 9 of the LCD display in accordance with FIG. 2B is at a greater distance from the carrier 5, namely approximately 50 mm.

The use of semiconductor bodies 3 of equal type and/or optoelectronic components 4 comprising semiconductor bodies 3 of equal type as radiation sources in an illumination device 1 which, in particular, emit radiation having a spectrum of equal type, the color locus of which lies in the white region of the CIE standard chromaticity diagram, advantageously makes it possible to reduce the height of the illumination device 1 and/or of a display comprising such an illumination device 1 since, in contrast to an illumination device 1 comprising different-colored radiation sources, there is no need to provide any height for color mixing.

An optoelectronic component 4 such as can be used for example in the case of the illumination device 1 in FIG. 2A and/or in the case of the LCD display in FIG. 2B is described in greater detail below with reference to FIGS. 3A to 3C.

The optoelectronic component 4 in accordance with the exemplary embodiment of FIGS. 3A to 3C has a component housing 18 having a recess 19, into which a semiconductor body 3 is mounted. The semiconductor body 3 is suitable for emitting electromagnetic radiation of a first wavelength range from its front side 6. The semiconductor body 3 is applied with its rear side 20, which lies opposite the radiation-emitting front side 6, onto a structured metallization 21 of the recess 19 in such a way that there is an electrically conductive connection between the semiconductor body 3 and the metallization 21. Furthermore, the front side 6 of the semiconductor body 3 is electrically conductively connected to a further part of the metallization 21 by means of a bonding wire 22. The metallization 21, for its part, is in each case electrically conductively connected to an external connection strip 23 of the component housing 18, wherein the structuring of the metallization 21 prevents a short circuit during operation.

In a manner succeeding the semiconductor body 3 in the emission direction 8 of the semiconductor body 3, an optical element 24 is applied onto the component housing 18. In the present case, the optical element 24 is a lens in which a radiation exit area 25 has a concavely curved partial region 26 and a convexly curved partial region 28, which at least partly surrounds the concave partial region 26 at a distance from the optical axis 27, wherein an optical axis 27 of the optical element 24 runs through the concavely curved partial region 26. In this case, the semiconductor body 3 is arranged in a manner centered with respect to the optical axis 27.

In the case of the component 4 in accordance with FIGS. 3A to 3C, the lens 27 is produced separately and placed onto the component housing 18.

The semiconductor body 3 of the optoelectronic component 4 in accordance with FIGS. 3A to 3C furthermore has a wavelength converting layer 29 comprising two wavelength conversion substances 30, 31. The wavelength conversion substances 30, 31 are not depicted in FIG. 3A, for the sake of clarity.

The optoelectronic component 4 in accordance with the exemplary embodiment of FIGS. 3A to 3C furthermore has a potting 32, which encapsulates the semiconductor body 3 with the wavelength converting layer 29 and completely fills the recess 19 in the present case. The potting 32 comprises a matrix material, for example a silicone or an epoxide.

The semiconductor body 3 which can be used in the optoelectronic component 4 in FIGS. 3A to 3C or the illumination device in accordance with FIG. 1A is described in detail below on the basis of the exemplary embodiment in accordance with FIG. 4A.

The semiconductor body 3 in accordance with the exemplary embodiment of FIG. 4A has an active zone 33, which is suitable for generating radiation of a first wavelength range. The active zone 33 is part of an epitaxially grown semiconductor layer sequence and preferably comprises a pn junction, a double heterostructure, a single quantum well or particularly preferably a multiple quantum well structure (MQW) for generating radiation. Examples of MQW structures are described in the documents WO 01/39282, U.S. Pat. No. 5,831,277, U.S. Pat. No. 6,172,382 B1 and U.S. Pat. No. 5,684,309, the disclosure content of which in this respect is hereby incorporated by reference.

In the present case, the semiconductor body 3 is based on a nitride compound semiconductor material and is suitable for generating radiation of the blue spectral range. The semiconductor body 3 therefore emits radiation of the first wavelength range comprising blue radiation from its front side 6 during operation.

The wavelength converting layer 29 is applied in direct contact onto the radiation-emitting front side 6 of the semiconductor body 3 of the exemplary embodiment of FIG. 4A. The wavelength converting layer 29 and the radiation-emitting front side 6 of the semiconductor body 3 therefore form a common interface.

The wavelength converting layer 29 comprises a first wavelength conversion substance 30, which is suitable for converting radiation of the first wavelength range into radiation of a second wavelength range, which is different from the first wavelength range. Furthermore, the wavelength converting layer 29 comprises a second wavelength conversion substance 31, which is suitable for converting radiation of the first wavelength range into radiation of a third wavelength range, which is different from the first and second wavelength ranges.

The semiconductor body 3 in accordance with the exemplary embodiment of FIG. 4A is suitable for emitting radiation from the blue spectral range. The first wavelength range therefore comprises radiation of the blue spectral range. In order to generate blue radiation, a semiconductor body 3 based on a nitride compound semiconductor material is suitable, for example.

In the present case, the first wavelength conversion substance 30 is suitable for converting blue radiation of the first wavelength range into green radiation. In this case, the second wavelength range comprises radiation of the green spectral range. By way of example, a europium-doped chlorosilicate is suitable as wavelength conversion substance 30 for this purpose.

In the present case, the second wavelength conversion substance 31 is suitable for converting blue radiation of the first wavelength range into radiation of the red spectral range. The third wavelength range thus comprises radiation of the red spectral range. By way of example, a europium-doped silicon nitride is suitable as wavelength conversion substance 31 for this purpose.

Preferably, the europium-doped chlorosilicate and the europium-doped silicon nitride have a ratio with respect to one another of between 0.8 and 1.2 and particularly preferably between 0.9 and 1.1 (in each case relative to mass fractions), in each case inclusive of the limits.

In the present case, the wavelength converting layer 29 on the semiconductor body 3 in accordance with FIG. 4A coverts a part of the blue radiation of the first wavelength range into green radiation of the second wavelength range with the aid of the first wavelength conversion substance 30 and a further part of the blue radiation of the first wavelength range into red radiation of the third wavelength range with the aid of the second wavelength conversion substance 31, while a part of the blue radiation of the first wavelength range passes through the wavelength converting layer 29 without being converted. The wavelength converting layer 29 or the optoelectronic component 4 in accordance with FIGS. 3A to 3C which comprises the semiconductor body 3 in accordance with FIG. 4A therefore emits mixed radiation comprising blue radiation of the first wavelength range, green radiation of the second wavelength range and red radiation of the third wavelength range. The color locus of this mixed radiation preferably lies in the white region of the CIE standard chromaticity diagram.

In the present case, the optoelectronic components 4 of FIGS. 3A to 3C which are contained in the illumination device 1 in accordance with FIG. 1 are grouped in accordance with their color locus. That is to say that the color loci of the mixed radiation emitted by the wavelength converting layers 29 on the semiconductor bodies 3 or optoelectronic components 4 are preferably situated within a MacAdams ellipse with three SDCM (Standard Deviation of Color Matching). In other words, the color loci of the mixed radiation emitted by the wavelength converting layers 29 or optoelectronic components 4 deviate by not more than three SDCM from a predetermined value.

In the exemplary embodiment of FIG. 4A, the first wavelength conversion substance 30 and the second wavelength conversion substance 31 are introduced into a matrix material 34. The matrix material 34 can for example comprise silicone and/or epoxide or consist of one of these materials or a mixture of these materials.

Only the differences between the semiconductor body 3 in accordance with the exemplary embodiment of FIG. 4A and the semiconductor body 3 in accordance with the exemplary embodiment of FIG. 4B are described below, in order to avoid repetitions. The remaining features of the semiconductor body 3 in FIG. 4B can be embodied for example in accordance with the exemplary embodiment of FIG. 4A.

In contrast to the semiconductor body 3 in accordance with the exemplary embodiment of FIG. 4A, the semiconductor body 3 in accordance with the exemplary embodiment of FIG. 4B has two separate wavelength converting layers 29, 35, each comprising a wavelength conversion substance 30, 31. Therefore, in the exemplary embodiment of FIG. 4B, the two wavelength conversion substances 30, 31 are comprised by two separate wavelength converting layers 29, 35. The first wavelength conversion substance 30 is comprised by a first wavelength converting layer 29, which is applied in direct contact onto the radiation-emitting front side 6 of the semiconductor body 3. This means that the first wavelength converting layer 29 forms a common interface with the radiation-emitting front side 6 of the semiconductor body 3. A second wavelength converting layer 35, which comprises the second wavelength conversion substance 31, is applied onto the first wavelength converting layer 29.

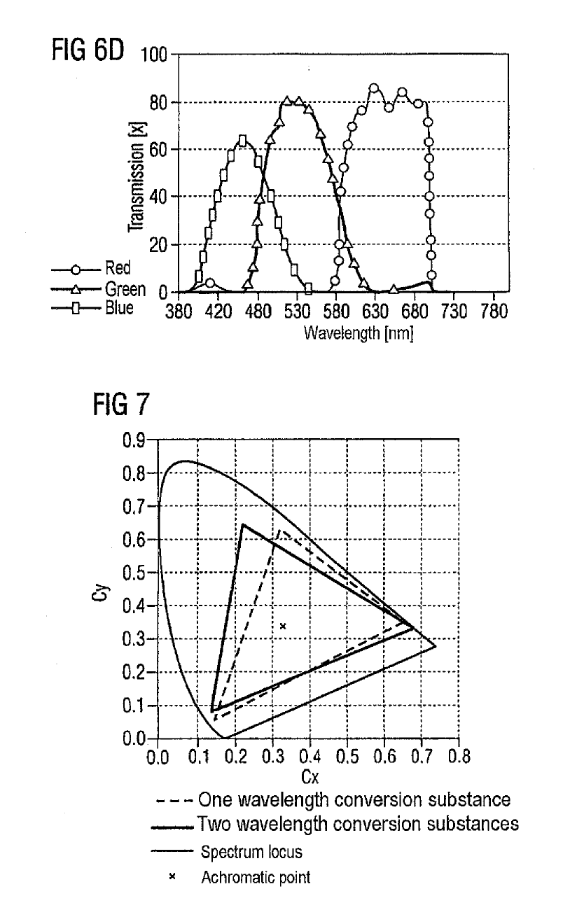

As described with reference to FIGS. 3A to 3C in conjunction with FIGS. 4A and 48, an optoelectronic component 4 suitable for being used as a light source in the illumination device 1 in accordance with FIG. 1A comprises two different wavelength conversion substances 30, 31, which can be comprised for example by a common or by two separate wavelength converting layers 29, 35.

As an alternative, it is also possible for the wavelength conversion substances 30, 31 to be comprised by the potting 32, which envelops the semiconductor body 3. Furthermore, it is also possible for one wavelength conversion substance 30 to be introduced in a wavelength converting layer 29 which, by way of example, is arranged on the radiation-emitting front side 6 of the semiconductor body 3, and for the other wavelength conversion substance 31 to be introduced into the potting 32, which encapsulates the semiconductor body 3.

The lens 24 comprised by the optoelectronic component 4 in accordance with FIGS. 3A to 3C is suitable, on account of the curved radiation exit area 25 described above, for expanding the emission characteristic of the optoelectronic component 4, as can be seen on the basis of the ray path in FIG. 3C. In particular a semiconductor body 3 comprising one or two wavelength converting layers 29, 35, such as has been described by way of example with reference to FIGS. 4A and 4B, constitutes a point radiation source relative to the optical element 24. The radiation of this point radiation source is expanded by the optical element 24 over a large solid angle, as can be gathered from the ray path in FIG. 3C.

The optoelectronic component 4 in accordance with the exemplary embodiment of FIG. 5 has a preformed component housing 18, into which a leadframe is introduced. The leadframe has two electrically conductive connection strips 23 which project laterally from the component housing 18 and are provided for externally making electrical contact with the component 4.

The component housing 18 furthermore has a recess 19, in which a radiation-emitting semiconductor body 3 is arranged. The radiation-emitting semiconductor body 3 is electrically conductively connected by its rear side 20, which lies opposite its radiation-emitting front side 6, to one electrical connection strip 23 of the leadframe, for example by means of a solder or an electrically conductive adhesive. Furthermore, the semiconductor body 3 is electrically conductively connected by its front side 6 to the other electrical connection strip 23 by means of a bonding wire 22 in an electrically conductive manner.

The component housing 18 furthermore has a potting 32, which fills the recess 19 of the component housing 18. Furthermore, the potting 32 forms a radiation exit area 25 curved in a lens-shaped fashion above the recess 19. In other words, the potting 32 of the optoelectronic component 4 is embodied as an optical element 24, as a lens in the present case. In contrast to the optoelectronic component 4 in accordance with FIGS. 3A to 3C, therefore, the optical element 24 is not produced separately and emplaced subsequently, but rather is integrated into the optoelectronic component 4.

The semiconductor body 3 in accordance with FIG. 5 is a thin-film semiconductor body. In the present case, the term thin-film semiconductor body denotes a semiconductor body 3 having an epitaxially grown, radiation-generating semiconductor layer sequence, wherein a growth substrate has been removed or thinned in such a way that it no longer sufficiently mechanically stabilizes the thin-film semiconductor body by itself. The semiconductor layer sequence of the thin-film semiconductor body, which particularly preferably comprises the active zone 33 of said thin-film semiconductor body, is therefore preferably arranged on a semiconductor body carrier which mechanically stabilizes the semiconductor body and, particularly preferably, is different from the growth substrate for the semiconductor layer sequence of the semiconductor body. Furthermore, a reflective layer is preferably arranged between the semiconductor body carrier and the radiation-generating semiconductor layer sequence, said reflective layer having the task of directing the radiation from the semiconductor layer sequence to the radiation-emitting front side 6 of the thin-film semiconductor body. The radiation-generating semiconductor layer sequence furthermore preferably has a thickness in the range of twenty micrometers or less, in particular in the range of ten micrometers.

The basic principle of a thin-film semiconductor body is described for example in the document I. Schnitzer et al., Appl. Phys. Lett. 63, 16, 18 Oct. 1993, pages 2174-2176, the disclosure content of which in this respect is hereby incorporated by reference.

In a manner running around the recess 19, the component housing 18 has a grooved recess 17, which is provided for at least reducing any escape of the potting 32 from the recess 19.

The semiconductor body 3 is based on a nitride compound semiconductor material in the present case. It has a semiconductor layer sequence having an active zone 33 provided for emitting radiation from the blue spectral range. The first wavelength range therefore comprises radiation from the blue spectral range. Furthermore, one or two wavelength converting layers 29, 35 can be situated on the semiconductor body 3, as described with reference to FIGS. 4A and 4B. Furthermore, it is also possible for at least one of the two wavelength conversion substances 30, 31 to be introduced into a matrix material of the potting 32.

In the present case, the potting 32 comprises a UV-curing silicone material as matrix material. Furthermore, it is also possible for the potting 32 to comprise one of the matrix materials mentioned above in connection with the wavelength converting layers 29, 35.

FIG. 6A shows, by way of example, an emission spectrum of a semiconductor body 3 based on a nitride compound semiconductor material—InGaN in the present case—such as can be used for example in the exemplary embodiment in accordance with FIGS. 4A and 4B. The emission spectrum of the semiconductor body 3 has, within a wavelength range of between approximately 400 nm and approximately 500 nm, a peak with a maximum at approximately 455 nm. The first wavelength range therefore comprises the range between approximately 400 nm and approximately 500 nm and comprises radiation of the blue spectral range.

FIG. 6B shows an emission spectrum of a europium-doped chlorosilicate as first wavelength conversion substance 30 and the emission spectrum of a europium-doped silicon nitride as second wavelength conversion substance 31. Furthermore, FIG. 6B shows the emission spectrum of the semiconductor body 3 with the emission spectrum from FIG. 6A, the radiation-emitting front side 6 of which has a wavelength converting layer 29 comprising the europium-doped chlorosilicate with the emission spectrum that is likewise illustrated in FIG. 6B as first wavelength conversion substance 30 and the europium-doped silicon nitride, likewise with the emission spectrum illustrated in FIG. 6B, as second wavelength conversion substance 31. This emission spectrum can be generated for example by a semiconductor body 3 and a wavelength converting layer 29, 35 in accordance with the exemplary embodiment of FIG. 4A.

The emission spectrum of the europium-doped chlorosilicate has, within a wavelength range of between approximately 460 nm and approximately 630 nm, a peak with a maximum at approximately 510 nm. The second wavelength range emitted by the europium-doped chlorosilicate thus comprises the wavelength range between approximately 460 nm and approximately 630 nm and comprises radiation of the green spectral range.

The emission spectrum of the europium-doped silicon nitride has a peak within the wavelength range of approximately 550 nm and approximately 780 nm with a maximum of approximately 600 nm. The third wavelength range emitted by the europium-doped silicon nitride thus comprises the wavelength range between approximately 550 nm and approximately 780 nm and comprises radiation of the red spectral range.

A wavelength converting layer 29, 35 comprising the two wavelength conversion substances 30, 31 with the emission spectra from FIG. 6B on the radiation-emitting front side 6 of a semiconductor body 3 with the emission spectrum from FIG. 6A emits mixed radiation comprising unconverted blue radiation of the first wavelength range, converted green radiation of the second wavelength range and converted red radiation of the third wavelength range.

The emission spectrum of the mixed radiation, which is likewise illustrated in FIG. 6B, has a peak in the blue spectral range between approximately 400 nm and approximately 500 nm with a maximum at approximately 455 nm, which comprises the proportion of the blue radiation of the first wavelength range generated by the semiconductor body which is not converted by the two wavelength conversion substances.

Furthermore, the emission spectrum of the mixed radiation has a peak in the green spectral range between approximately 460 nm and between approximately 630 nm with a maximum at approximately 510 nm, which comprises radiation of the second wavelength range which is converted by the europium-doped chlorosilicate. Between approximately 550 nm and approximately 780 nm, the emission spectrum has a further peak with a maximum at approximately 600 nm, which comprises red radiation of the third wavelength range which is converted by the europium-doped silicon nitride.

FIG. 6C shows for comparison the emission spectrum of a wavelength converting layer on a semiconductor body with the emission spectrum from FIG. 6A, wherein the wavelength converting layer comprises only a single wavelength conversion substance rather than two different wavelength conversion substances as provided in accordance with the present invention. The wavelength conversion substance, YAG:Ce in the present case, the emission spectrum of which is likewise illustrated in FIG. 6C, is suitable for converting radiation of the blue spectral range into radiation of the yellow spectral range. The emission spectrum of this wavelength conversion substance therefore has, in the yellow spectral range between approximately 460 nm and approximately 730 nm, a peak with a maximum at approximately 550 nm.

FIG. 6D shows the transmission spectra of a color filter 15, preferably for an LCD display, in accordance with a first exemplary embodiment, which has red regions, green regions and blue regions. Such a color filter 15 can be integrated for example into the LCD layer 2 of the display in accordance with the exemplary embodiments 1B and 2B. The transmission spectrum of the blue regions has a peak in the blue spectral range between approximately 390 nm and approximately 540 nm with a maximum at approximately 450 nm. The transmission spectrum of the green regions has a peak in the green spectral range between approximately 450 nm and 630 nm with a maximum at approximately 530 nm, while the transmission spectrum of the red regions has a peak in the red spectral range between approximately 570 nm and approximately 700 nm with a plateau region between approximately 600 nm and approximately 630 nm.

A comparison of the emission spectrum of the mixed radiation from FIG. 6B, the emission spectrum of the mixed radiation from FIG. 6C and the transmission spectra of the color filter 15 from FIG. 6D shows that the color filter 15 transmits significantly more portions of the mixed radiation from FIG. 6A, which is generated with the aid of two wavelength conversion substances 30, 31, than the mixed radiation from FIG. 6C, which is generated with the aid of only one wavelength conversion substance.

The mixed radiation with the emission spectrum from FIG. 6B is adapted to the red region of the color filter with the transmission spectra from FIG. 6D in such a way that at least 55 percent of the red radiation of the third wavelength range is transmitted by the red region of the color filter. Furthermore, the green regions of the color filter transmit at least 65 percent of the green radiation of the second wavelength range and the blue regions transmit 55 percent of the blue radiation of the first wavelength range. The mixed radiation with the emission spectrum from FIG. 6B is therefore adapted to the color filter with the transmission spectra from FIG. 6D.

FIG. 7 shows the color triangle for an illumination device 1 comprising a semiconductor body 3 and wavelength conversion substances 30, 31 in accordance with the exemplary embodiment of FIG. 6B (solid line) and the color triangle for an illumination device comprising a semiconductor body and a wavelength conversion substance in accordance with FIG. 6C (dashed line). A comparison of the two color triangles shows that it is advantageously possible to obtain a larger color triangle with the use of two wavelength conversion substances than with only one wavelength conversion substance.

This patent application claims the priority of the two German patent applications 10 2008 006 975.2 and 10 2008 029 191.9, the disclosure content of which is in each case hereby incorporated by reference.

The invention is not restricted by the description on the basis of the exemplary embodiments. Rather, the invention encompasses any novel feature and also any combination of features, which in particular includes any combination of features in the patent claims, even if these feature or this combination of features itself are not explicitly specified in the patent claims or exemplary embodiments.

1. An illumination device for backlighting a display comprising:
at least one semiconductor body, suitable for generating electromagnetic radiation of a first wavelength range;
a first wavelength conversion substance, which is disposed downstream of the radiation-emitting front side of the semiconductor body in the emission direction thereof and is suitable for converting radiation of the first wavelength range into radiation of a second wavelength range, which is different from the first wavelength range; and
a second wavelength conversion substance, which is disposed downstream of the radiation-emitting front side of the semiconductor body in the emission direction thereof and is suitable for converting radiation of the first wavelength range into radiation of a third wavelength range, which is different from the first and second wavelength ranges.

2. The illumination device as claimed in claim 1, wherein the first and/or the second wavelength conversion substance are comprised by a wavelength converting layer applied in direct contact onto the radiation-emitting front side of the semiconductor body.

3. The illumination device as claimed in claim 1, wherein the first and/or the second wavelength conversion substance are comprised by a potting.

4. The illumination device as claimed in claim 1, wherein the first wavelength range comprises radiation of the blue spectral range.

5. The illumination device as claimed in claim 1, wherein the second wavelength range comprises radiation of the green spectral range.

6. The illumination device as claimed in claim 5, wherein the first wavelength conversion substance comprises a europium-doped chlorosilicate.

7. The illumination device as claimed in claim 1, wherein the third wavelength range comprises radiation from the red spectral range.

8. The illumination device as claimed in claim 7, wherein the second wavelength conversion substance comprises a europium-doped silicon nitride.

9. The illumination device as claimed in claim 1, which comprises a europium-doped chlorosilicate as first wavelength conversion substance and a europium-doped silicon nitride as second wavelength conversion substance, wherein the europium-doped chlorosilicate has, with respect to the europium-doped silicon nitride, a ratio of between 0.8 and 1.2, inclusive of the limits.

10. The illumination device as claimed in claim 1, which emits radiation having a color locus in the white region of the CIE standard chromaticity diagram and the emission spectrum of which is adapted to the transmission spectra of a color filter with red regions, green regions and blue regions.

11. The illumination device as claimed in claim 1, wherein an optical element is arranged above the semiconductor body, the first wavelength conversion substance and the second wavelength conversion substance.

12. The illumination device as claimed in claim 11, wherein a radiation exit area of the optical element has a concavely curved partial region and a convexly curved partial region, which at least partly surrounds the concave partial region at a distance from the optical axis, wherein an optical axis of the optical element runs through the concavely curved partial region.

13. The illumination device as claimed in claim 1, which has a plurality of semiconductor bodies grouped in accordance with their color loci.

14. A display having an illumination device as claimed in claim 1 for backlighting.

15. The display as claimed in claim 14, which has a color filter with red regions, green regions and blue regions, wherein the emission spectrum of the illumination device are adapted to the transmission spectra of the color filter.
